(19) United States
(12) Patent Application Publication
(10) Pub. No.: US 2026/0248109 A1
(43) Pub. Date: Aug. 27, 2026

(54) ANIMAL FEED DISTRIBUTION APPARATUS WITH MOVABLE COVER MEMBER

(71) Applicant: Hog Slat, Inc., Newton Grove, NC (US)

(72) Inventors: Tyler Clay Marion, Clayton, NC (US); Andrew Clarence Mitchell, Clinton, NC (US)

(21) Appl. No.: 19/548,353

(22) Filed: Feb. 24, 2026

Related U.S. Application Data
(60) Provisional application No. 63/762,725, filed on Feb. 25, 2025.

(51) Int. Cl. A01K 39/01; A01K 39/012; A01K 39/014

(52) U.S. Cl. CPC A01K 39/0106; A01K 39/0125; A01K 39/014

(57) ABSTRACT

A trough-type animal feed distribution apparatus that includes a cover member that is movable by way of an actuating mechanism relative to upper edges of at least one trough segment between (i) a lower, closed position is configured to block animal access to the trough segment and (ii) an upper, open position that is configured to enable animal access to the trough segment. A movable member comprises a shaft configured to rotate about a longitudinal axis extending parallel to the trough segment, and at least one tether extending between the shaft and the cover member, wherein rotation of the shaft causes the tethers to be selectively wrapped around the shaft to raise or lower the cover member.

### CROSS-REFERENCE TO RELATED APPLICATION(S)

This application claims priority to U.S. Provisional Patent Application No. 63/762,725 filed on February 25, 2025, wherein the entire contents of the foregoing application are hereby incorporated by reference herein.

### TECHNICAL FIELD

This disclosure relates generally to trough-style apparatuses for mechanically distributing granular feed material to animals (e.g., poultry).

### BACKGROUND

Efficient raising of poultry on a large scale may involve feeding a large number of birds using a feed distribution trough into which granular feed is supplied. A flat chain may be arranged on a bottom portion of a trough and moved within the trough to convey feed to numerous bird positioned adjacent thereto. The trough may be joined with curved corner sections to form a closed circuit, with the flat chain forming an endless loop therein. A drive mechanism including a sprocket may be used to move the flat chain within the trough, and at least one hopper may be used to supply granular feed material to the trough for distribution by motion of the flat chain.

FIG. 1 is a simplified schematic diagram showing a generally rectangular endless loop feeding circuit 10 including four corner sections 16 joined by trough segments 20 suitable for containing a movable flat chain (18 in FIG. 2), with a drive unit 12 or moving the flat chain, and with a hopper 14 for dispensing granular feed material into a trough segment 20 to be conveyed by the flat chain around the feeding circuit 10. FIG. 2 is a perspective view of a portion of an endless loop feeding circuit of the type depicted in FIG. 1, showing two corner sections 16 and corresponding trough segments 20 thereof, with a flat chain 18 being visible within one trough segment 20. In use, feed may be periodically supplied by a hopper to feeding circuit of the type shown in FIGS. 1-2, such as at a feeding frequency of once per day or once every other day.

One concern with utilization of trough-based poultry feeding systems such as described in connection with FIG. 1 is that it takes time for feed to be distributed over an entire feeding circuit, and hungry birds frequently compete to position themselves as close as possible to a trough section immediately downstream of a hopper outlet to enable rapid access to feed when dispensation of feed material is initiated. This competition frequently leads to aggression between birds (which may result in injury) and uneven growth rates between birds. A known approach to reduce access to feeding troughs after initiation of feed dispensation from a hopper into a trough, but before feed material is initially distributed by a flat chain over an entire feeding circuit, is to maintain the entire feeding circuit at a first elevated position during the initial distribution process, and then (after at least a portion of the feed material is distributed) to lower the feeding circuit to a second lower position proximate to a floor of a poultry enclosure to permit feeding. However, this approach requires the use of winches to selectively raise and lower the feeding circuit, and birds that can fly may also access a feeding circuit in the elevated position.

Need exists in the art for apparatuses capable of addressing limitations associated with existing animal feed material distribution systems.

### SUMMARY

Aspects of the present disclosure relate to a trough-type animal feed distribution apparatus that includes a movable cover member. A cover member is movable relative to a trough between (i) a lower, closed position is configured to block animal access to the trough and (ii) an upper, open position that is configured to enable animal access to the trough. The cover member may be arranged in the closed position during initial dispensation of granular feed material from a hopper into a trough segment, and while the feed material is initially distributed (e.g., by a flat chain) over at least a substantial portion of an entire feeding circuit. After the feed material is distributed over at least a substantial portion (e.g., a majority or an entirety) of a feeding circuit, the cover member may be moved to the open position to “present” the feed material to multiple animals (e.g., birds). When the feed material is distributed over a majority or an entirety of the feeding circuit at the time of presentation, the animals to be fed are not motivated to compete to be present at a specific position (e.g., proximate to a hopper outlet) when a feeding operation is initiated. This reduced competition may reduce aggressive interaction between animals and resulting animal injury or death. If desired, a feeding circuit may be maintained close to ground level in certain embodiments, thereby reducing a need for repeatedly raising and lowering a feeding circuit using winches during periods of initial feed distribution.

In one aspect, the disclosure relates to an animal feed distribution apparatus comprising: at least one trough segment comprising a trough bottom wall spanning between trough sidewalls, the trough sidewalls comprising upper edges, and the at least one trough segment being configured to receive a movable conveying mechanism for distributing granular animal feed material along a length of the at least one trough segment; a cover member configured to selectively block animal access to the trough, the cover member being movable between (i) a lower, closed position that is proximate to the upper edges of the trough sidewalls and is configured to block animal access to the at least one trough segment and (ii) an upper, open position that is distal from the upper edges of the trough sidewalls and is configured to enable animal access to the at least one trough segment; and an actuating mechanism configured to move the cover member between the lower, closed position and the upper, open position.

In certain embodiments, the at least one trough segment consists of a single trough segment.

In certain embodiments, the movable member comprises a shaft having a longitudinal axis extending in a longitudinal substantially parallel to the trough bottom wall; the shaft is configured to rotate around the longitudinal axis; rotation of the shaft in a first direction is configured to cause a portion of the at least one tether to be wrapped around the shaft to move the cover member from the lower, closed position toward the upper, open position; and rotation of the shaft in a second direction is configured to cause a portion of the at least one tether to be unwrapped relative to the shaft to move the cover member from the upper open position to toward the lower, closed position.

In certain embodiments, the shaft comprises at least one spool region configured to receive a corresponding at least one tether; rotation of the shaft in the first direction is configured to cause a portion of the at least one tether to be wrapped around the at least one spool region of the shaft; and rotation of the shaft in the second direction is configured to cause a portion of the at least one tether to be unwrapped relative to the at least one spool region of the shaft.

In certain embodiments, the actuating mechanism further comprises: a motor or other rotary actuator configured to drive rotation of the shaft; and a plurality of shaft interface members coupled with the at least one trough segment and configured to support the shaft above the at least one trough segment, with the shaft being permitted to rotate relative to the plurality of shaft interface members.

In certain embodiments, each shaft interface member of the plurality of shaft interface members comprises a bushing or a bearing.

In certain embodiments, each shaft interface member of the plurality of shaft interface members is configured to receive a lifting cable or lifting chain couplable to a winch to permit the entire animal feed distribution apparatus to be raised and lowered.

In certain embodiments, the apparatus further comprises a roosting prevention member spanning between adjacent shaft interface members of the plurality of shaft interface members.

In certain embodiments, the movable conveying mechanism comprises a movable flat chain.

In certain embodiments, the apparatus further comprises at least one travel stop positioned within the trough to prevent the cover member from contacting the movable conveying mechanism.

In certain embodiments, the at least one trough segment comprises first and second trough segments arranged in parallel to one another.

In certain embodiments, an upper edge portion of the first trough segment is spaced apart from an adjacent upper edge portion of the second trough segment by a distance of no greater than 8 inches.

In certain embodiments, an upper edge portion of the first trough segment is arranged in contact with an upper edge portion of the second trough segment.

In certain embodiments, the cover member comprises a first cover member portion configured to block animal access to the first trough segment, and comprises a second cover member portion configured to block animal access to the second trough segment.

In certain embodiments, the actuating mechanism comprises a movable member positioned above the cover member, and at least one tether extending between the movable member and the cover member; motion of the movable member is configured to cause the at least one tether to move the cover member between the lower, closed position and the upper, open position; and the animal feed distribution apparatus further comprises a pivotal link between the movable member and the cover member.

In certain embodiments, the apparatus further comprises one or more structural bracing members arranged between the first cover member portion and the second cover member portion.

In another aspect, the disclosure relates to an animal feed distribution system comprising: a plurality of animal feed distribution apparatuses as described herein, with trough segments of the plurality of animal feed distribution apparatuses arranged as part of a closed circuit containing a continuous flat chain arranged as an endless loop; a plurality of corner sections each coupled to one or more trough segments of the plurality of animal feed distribution apparatuses, with the continuous flat chain extending through the plurality of corner sections; a hopper configured to supply granular feed material into the closed circuit; and a chain drive member configured to move the continuous flat chain to distribute granular feed material through the closed circuit including trough segments of the plurality of animal feed distribution apparatuses.

In another aspect, any one or more aspects or features described herein may be combined with any one or more other aspects or features for additional advantage.

Other aspects and embodiments will be apparent from the detailed description and accompanying drawings.

Those skilled in the art will appreciate the scope of the present disclosure and realize additional aspects thereof after reading the following detailed description of the preferred embodiments in association with the accompanying drawings.

### BRIEF DESCRIPTION OF THE DRAWINGS

FIG. 1 is a simplified top plan schematic view of a generally rectangular feeding circuit including four corner sections joined by trough suitable for containing a movable flat chain, with a drive mechanism for driving movement of the chain and a hopper for supplying granular feed material to the trough for distribution by movement of the flat chain.

FIG. 2 is a perspective view of a portion of an endless loop feeding circuit of the type depicted in FIG. 1, showing two corner sections and corresponding trough segments thereof, with a flat chain being visible within one trough segment

FIG. 3 is a perspective view of an animal feed distribution according to one embodiment of the present disclosure, including a trough segment containing a horizontally movable flat chain with a portion of a vertically movable cover member arranged in a closed position proximate to a top edge of the trough to block access to the trough, with the cover member having a cylindrical shape and being suspended by tethers below a rotatable shaft that is supported above the cover member by multiple shaft interface members, wherein directional rotation of the shaft is configured to selectively wrap or unwrap the tethers relative to the rotatable shaft to move the cover member between a lower, closed position and an upper, open position.

FIG. 4A is a perspective view of two discrete portions of an animal feed distribution apparatus separated by a symbolic break according to one embodiment, showing the cover member arranged in an upper, open position above a trough segment and supported by a tether wrapped around a rotatable shaft, with a shaft interface member being coupled with the trough segment and having an associated bushing supporting the shaft above the cover.

FIG. 4B depicts the same items as shown in FIG. 4A but with the cover member arranged in a lower, closed position relative to the trough member, with the tether at least partially unwrapped relative to the rotatable shaft.

FIG. 5A is a perspective view of an animal feed distribution apparatus 10 according to one embodiment incorporating the items of FIG. 4A with the cover member in the upper, open position, and further depicting multiple shaft interface members, multiple actuator support members, and an actuator assembly including a reversible motor configured to (i) drive rotation of the rotatable shaft in a first direction to wrap the tether around the shaft to raise the cover, and (ii) drive rotation of the rotatable shaft in a second direction to unwrap the tether relative to the shaft to lower the cover member.

FIG. 5B depicts the same items shown in FIG. 5A but with the cover member arranged in a lower, closed position relative to the trough member, with the tether at least partially unwrapped relative to the rotatable shaft.

FIG. 6 is a perspective view of an animal feed distribution apparatus according to one embodiment showing a cover member arranged in a lower, closed position relative to a trough segment and supported by a tether coupled with a rotatable shaft, further showing a roosting prevention cable tensioned between first and second shaft interface members supporting the rotatable shaft above the trough segment, and showing chains coupled with the shaft interface members suitable for supporting and/or lifting the animal feed distribution system.

FIG. 7A is a cross-sectional schematic view of a portion of an animal feed distribution system according to one embodiment, showing a cover member positioned above a trough segment having internal travel stops and containing a movable flat chain, with the cover member comprising a cylindrical tube having an outer diameter smaller than an internal width of the trough segment.

FIG. 7B shows the items of FIG. 7A, with the cover member positioned at least partially within the trough segment above travel stops configured to prevent the cover member from contacting the movable flat chain within the trough segment.

FIG. 8 is a cross-sectional schematic view of a portion of an animal feed distribution system according to one embodiment including a cover member positioned above a trough segment containing a movable flat chain, with the cover member comprising a cylindrical tube having an outer diameter greater than an internal width of the trough segment.

FIG. 9 is a cross-sectional schematic view of a portion of an animal feed distribution system according to one embodiment including a cover member positioned above a trough segment containing a movable flat chain, with the cover member comprising an oval tubular cross-sectional shape and having a maximum width greater than an internal width of the trough segment.

FIG. 10 is a cross-sectional schematic view of a portion of an animal feed distribution system according to one embodiment including a cover member positioned above a trough segment containing a movable flat chain, with the cover member comprising a semi-oval cross-sectional shape and having a maximum width greater than an internal width of the trough segment.

FIG. 11 is a cross-sectional schematic view of a portion of an animal feed distribution system according to one embodiment including a cover member positioned above a trough segment containing a movable flat chain, with the cover member comprising a chevron cross-sectional shape and having a maximum width greater than an internal width of the trough segment.

FIG. 12 is a cross-sectional schematic view of a portion of an animal feed distribution system according to one embodiment including a cover member positioned above a trough segment containing a movable flat chain, with the cover member comprising a generally triangular cross-sectional shape and having a maximum width greater than an internal width of the trough segment.

FIG. 13A is a cross-sectional schematic view of a portion of an animal feed distribution system according to one embodiment including a cover member having first and second cover member portions positioned above corresponding first and second trough segments containing a movable flat chain, with the cover member arranged in an upper, open position.

FIG. 13B is a cross-sectional schematic view of the animal feed distribution system portion of FIG. 13A, with the cover member arranged in a lower, closed position.

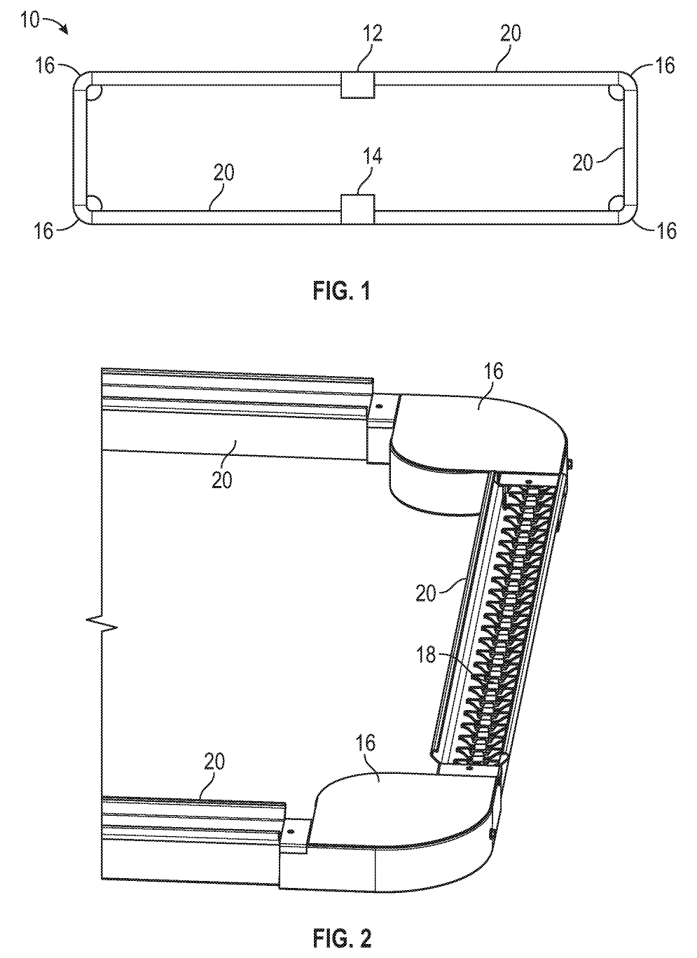

### DETAILED DESCRIPTION

The embodiments set forth below represent the necessary information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure and the accompanying claims.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure. As used herein, the term "and/or" includes any and all combinations of one or more of the associated listed items.

It will be understood that when an element such as a layer, region, or substrate is referred to as being "on" or extending "onto" another element, it can be directly on or extend directly onto the other element or intervening elements may also be present. In contrast, when an element is referred to as being "directly on" or extending "directly onto" another element, there are no intervening elements present. Likewise, it will be understood that when an element such as a layer, region, or substrate is referred to as being "over" or extending "over" another element, it can be directly over or extend directly over the other element or intervening elements may also be present. In contrast, when an element is referred to as being "directly over" or extending "directly over" another element, there are no intervening elements present. It will also be understood that when an element is referred to as being "connected" or "coupled" to another element, it can be directly connected or coupled to the other element or intervening elements may be present. In contrast, when an element is referred to as being "directly connected" or "directly coupled" to another element, there are no intervening elements present.

Relative terms such as "below" or "above" or "upper" or "lower" or "horizontal" or "vertical" may be used herein to describe a relationship of one element, layer, or region to another element, layer, or region as illustrated in the Figures. It will be understood that these terms and those discussed above are intended to encompass different orientations of the device in addition to the orientation depicted in the Figures.

The terminology used herein is for the purpose of describing particular embodiments only and is not intended to be limiting of the disclosure. As used herein, the singular forms "a," "an," and "the" are intended to include the plural forms as well, unless the context clearly indicates otherwise. It will be further understood that the terms "comprises," "comprising," "includes," and/or "including" when used herein specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

As noted previously herein, an animal feed distribution apparatus as disclosed herein includes a trough segment configured to receive a movable conveying mechanism for distributing granular animal feed material therein, a cover member configured be raised and lowered to selectively block animal access to the trough, and an actuating mechanism configured to move the cover member between a lower, closed position and an upper, open position. In certain embodiments, the conveying mechanism comprises a moveable flat chain, but alternatively may comprise an auger or other conveying means. In certain embodiments, the actuating mechanism comprises a rotatable shaft (e.g., configured to be rotated by a motor or other rotary actuator) to which one or more tethers are attached, wherein rotation of the shaft serves to selectively wrap or unwrap the tether(s) relative to the shaft to raise or lower a cover member to which the tether(s) are coupled. In alternative embodiments, the actuating mechanism may comprise one or more linear actuators or other devices configured to raise and lower a cover member.

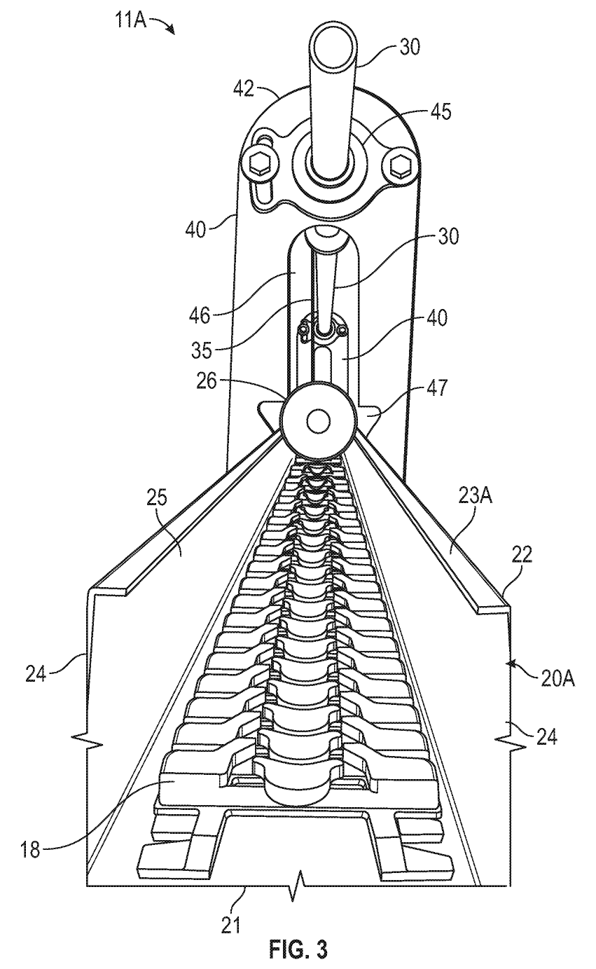

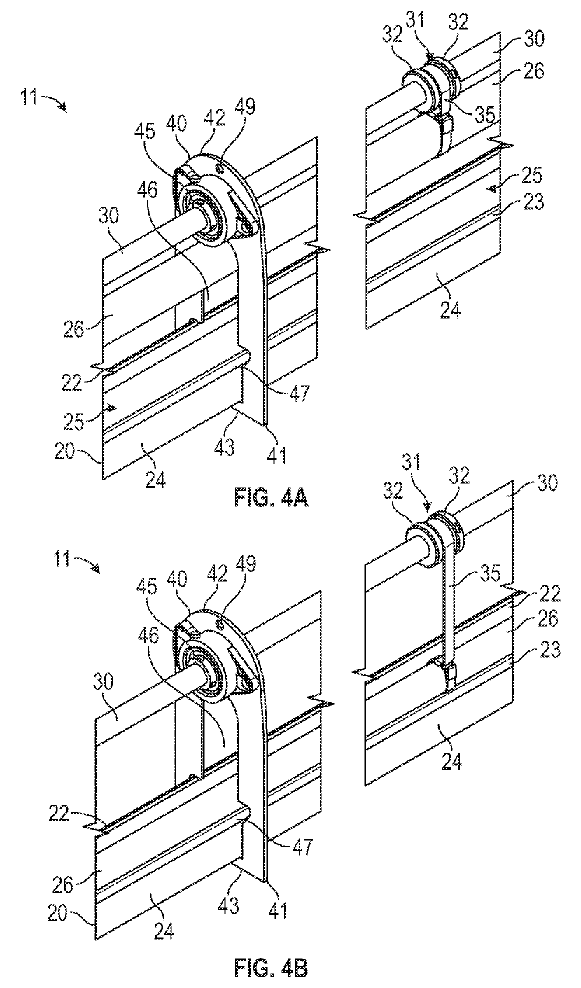

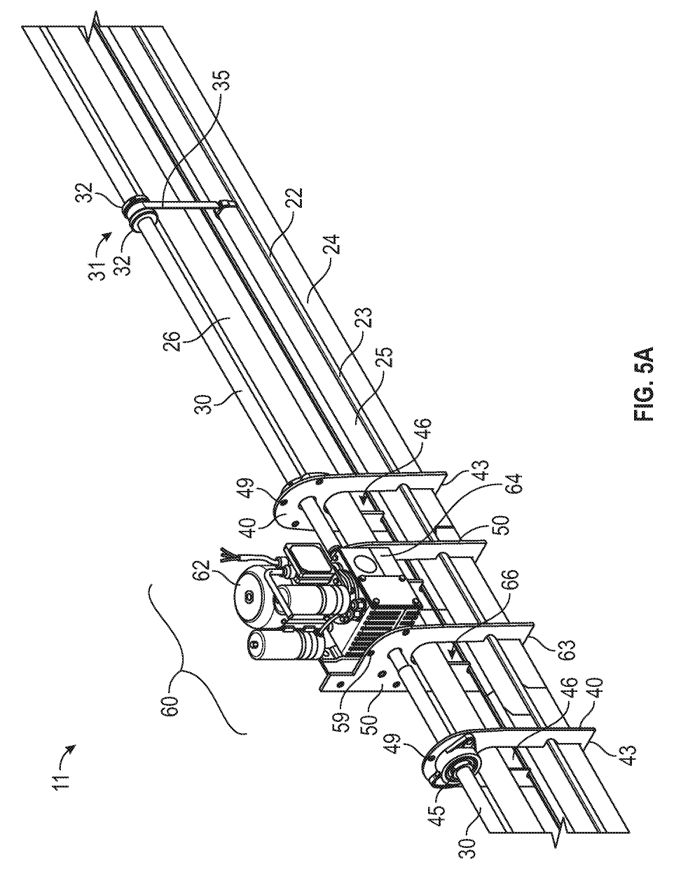

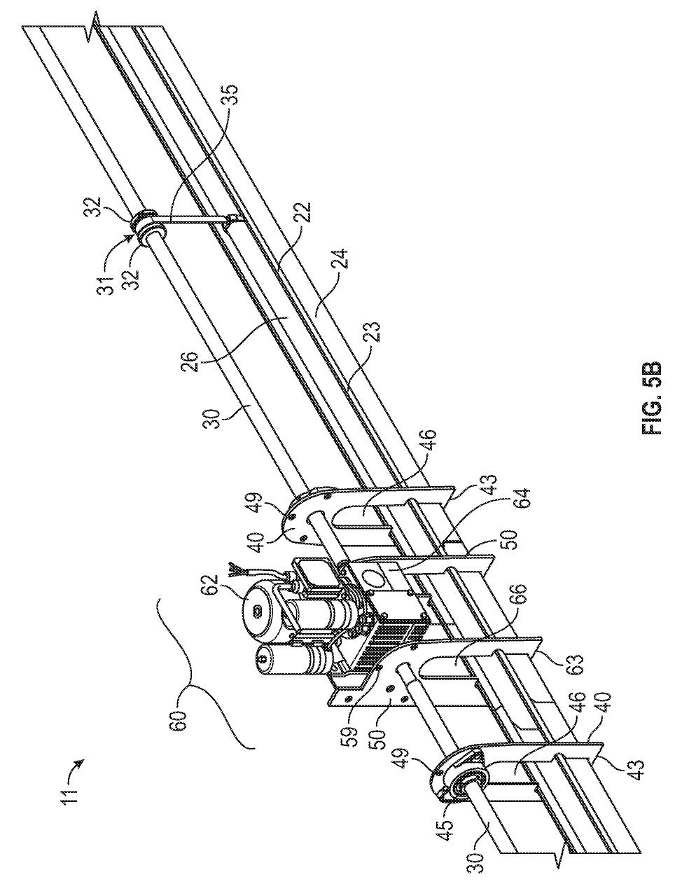

FIG. 3 is a perspective view of an animal feed distribution apparatus 11A according to one embodiment of the present disclosure, including a trough segment 20A containing a horizontally movable flat chain 18 (arranged to translate atop a bottom wall 21 of the trough segment 20A) with a portion of a vertically movable cover member 26 arranged in a closed position proximate to top edges 22 of sidewalls 24 of the trough segment 20A to block access to the trough. The particular trough segment 20A includes inwardly projecting lips 23A along the top edges 22 of the sidewalls 24 surrounding a trough opening 25, although in certain embodiments a trough segment may include outwardly projecting lips (e.g., 23 in FIGS. 4A to 5B). The cover member 26 has a hollow cylindrical shape (e.g., optionally embodying a round pipe) and is suspended by tethers 35 (e.g., straps, cables, or the like) below a rotatable shaft 30 that is supported above the cover member 26 by multiple shaft interface members 40. The shaft 30 is configured to be rotated by a motor or other rotary actuator (e.g., motor 62 in FIGS. 5A-5B), wherein directional rotation of the shaft 30 is configured to selectively wrap or unwrap the tethers 35 relative to the rotatable shaft 30 to move the cover member 26 between a lower, closed position (as shown in FIG. 3) and an upper, open position (e.g., as shown in FIGS. 4A and 5A). Each shaft interface member 40 may include a vertically aligned body having a lower end 41 (shown in FIGS. 4A to 5B), an upper end 42, and an elongated aperture 46 permitting vertical translation of the rotatable shaft 26, which extends through the aperture 46. The elongated aperture 46 may include lateral notches 47 for receiving outwardly extending lip portions (e.g., 23 in FIGS. 4A to 5B) of a trough segment. Each shaft interface member 40 further includes a bushing (or bearing) through which the shaft 30 extends, with the bushing or bearing arranged proximate to the upper end 42 and permitting the shaft 30 to freely rotate relative to the shaft interface member.

FIG. 4A is a perspective view of two discrete portions of an animal feed distribution apparatus 11 separated by a symbolic break according to an embodiment, showing a cylindrical cover member 26 arranged in an upper, open position above a trough segment 20 and supported by a tether 35 wrapped around a spool portion 31 of a rotatable shaft 30. The trough segment 20 includes sidewalls 24 bounded by top edges 22 with outwardly projecting lips 23, and includes a trough opening 25 between the top edge 22. A shaft interface member 40 including an elongated aperture 46 (permitting vertical translation of the cover member 26) is arranged between the trough segment 20 and the shaft 30, and includes a bushing or bearing 45 that permits rotary movement of the shaft 30 relative to the shaft interface member 40. The shaft interface member 40 includes a lower end 41 and an upper end 42, with the bushing or bearing 45 positioned proximate to the upper end 42, and with a trough support portion 43 along the lower end 41 to mechanically support the trough segment 20. Lateral notches 47 defined in the shaft interface member 40 along the aperture 46 are configured to receive outwardly protruding lips 23 of the trough segment 20. An upper opening 49 defined in the shaft interface member 40 proximate to the upper end 42 is arranged to receive a cable or chain (e.g., 79 in FIG. 6) suitable for supporting and/or lifting (e.g., using a winch) an animal feed distribution system incorporating the apparatus 11. The spool portion 31 of the shaft 30 includes increased diameter regions 32 configured to bound a position for receiving a length of the tether 26 when in a wrapped state. In certain embodiments, the spool portion 31 may be integrally formed with the shaft 30; in other embodiments, the spool portion 31 may be pre-formed and joined or otherwise attached to the shaft 30 (e.g., with adhesives, one or more fasteners, press-fitting, etc.).

FIG. 4B depicts the same items of animal feed distribution apparatus 11 as shown in FIG. 4A, but with the cover member 26 arranged in a lower, closed position relative to the trough segment 20. Such position may be attained by rotation of the shaft 30 in a suitable direction to cause at least a portion of the length of the tether 35 to be unwrapped relative to the shaft 30. With the cover member 26 in the lower, closed position, access to the trough opening 25 (shown in FIG. 4A) is blocked, such that animals would be unable to access any feed material within the trough 20.

FIG. 5A is a perspective view of an animal feed distribution apparatus 11 according to one embodiment incorporating the items of FIG. 4A with the cover member 26 in the upper, open position, and further depicting multiple shaft interface members 40, multiple actuator support members 50, and an actuator assembly 60 including a reversible motor 62 (and an associated gearbox 64) configured to drive rotation of the rotatable shaft 30 In particular, the actuator assembly 60 is configured to (i) drive rotation of the rotatable shaft 30 in a first direction to wrap the tether 35 around the shaft 30 (i.e., at the spool member 31 between increased diameter portions 32 thereof) to raise the cover member 26, and (ii) drive rotation of the rotatable shaft 30 in a second direction to unwrap the tether 35 relative to the shaft 30 to lower the cover member 26. The trough segment 20 includes sidewalls 24 terminating at an upper edge 22 with an outwardly projecting lip 23 bounding a trough opening 25. The trough segment is supported from below by trough support portions 43, 53 of the shaft interface members 40 and the actuator support members 50, with the shaft interface members 40 and the actuator support members 50 defining respective elongated apertures 46, 56 permitting vertical translation of the cover member 26. One or more bushings 45 or bearings may be provided for each shaft interface member 40 (and in certain embodiments may be provided for each actuator support member 50). The shaft interface members 40 and actuator support members 50 further include upper openings 49, 59 to receive a cable or chain (shown in FIG. 6) for lifting a feed distribution system incorporating the feed distribution apparatus 11. The reversible motor 62 embody a stepper motor or include stepwise control to permit a number of rotations of the shaft 26 (driven by the motor 62) to be controlled. In certain embodiments, one or more sensors (not shown) may be used to sense position of the cover member 26, and operation of the reversible motor 62 may be controlled at least in part based on signals generated by, or derived from, the one or more sensors.

FIG. 5B depicts the same items shown in FIG. 5A but with the cover member 26 arranged in a lower, closed position relative to the trough member 20 (e.g., to block access by animals to feed material within the trough member 26), with at least a portion of the tether 35 being unwrapped relative to the rotatable shaft 30. Such a state may be attained by rotating the shaft 30 by the motor 62 of the actuating assembly 60 to cause unwrapping of the tether 35 relative to the rotatable shaft 30.

FIG. 6 is a perspective view of an animal feed distribution apparatus 11A according to one embodiment (consistent with FIG. 3) showing a cover member 26 arranged in a lower, closed position relative to a trough segment 20A and supported by tethers 35 coupled with a rotatable shaft 30 (at spool portions 31 thereof). The trough segment 20A includes side walls 24 terminating at upper edges 22 with inwardly protruding lips 23A. Shaft interface members 40 each defining an elongated aperture 46 are arranged between the trough segment 20A and the rotatable shaft 30 with bushings 45 or bearings permitting rotation of the shaft 30 relative to the shaft interface members 40. An upper aperture 49 is provided in each shaft interface member 40 and receives both a chain 79 (for supporting and/or lifting a feed distribution system incorporating the feed distribution apparatus 11A) and a hook end of a spring 77 coupled with a horizontal cable 76 stretched parallel to and over the shaft 30 to serve as a roosting prevention element. A motor 62 configured to drive rotation of the shaft 30 is further shown in FIG. 6.

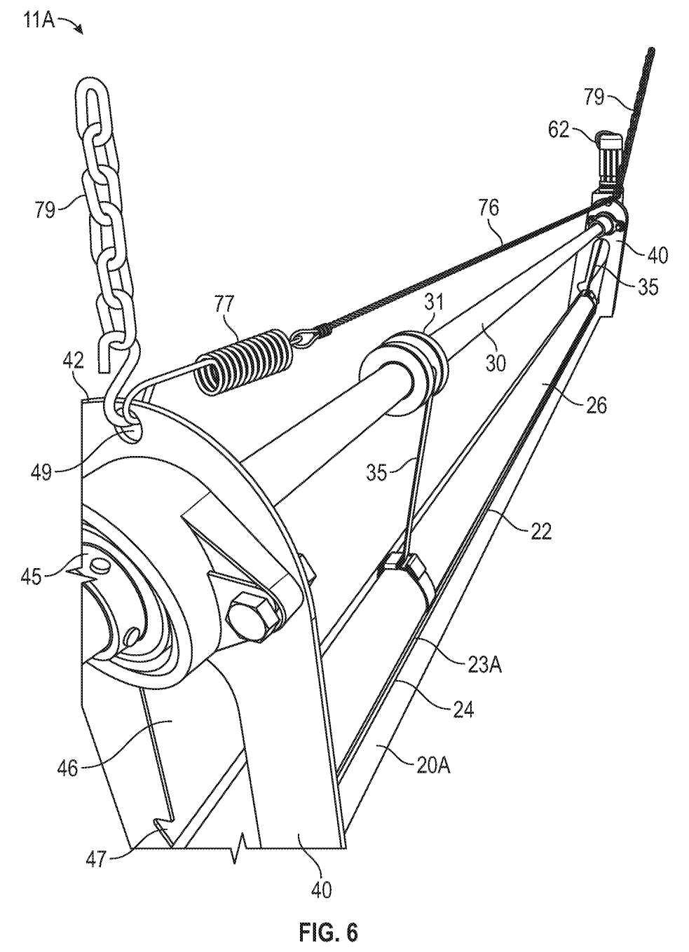

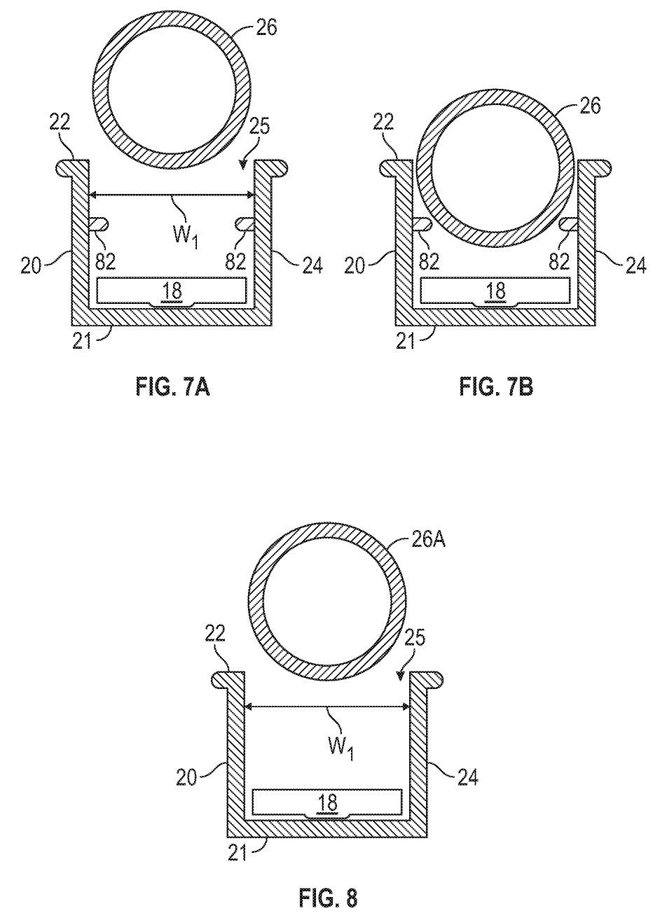

In certain embodiments, a cover member 26 as disclosed may have a maximum width that is smaller than an inner width of a trough segment (e.g., 20 or 20A). Such a configuration may be advantageous since it naturally counteracts efforts of animals to lift or dislodge a cover member from a trough segment when the cover member is in a lower, closed position. However, one concern associated with such a configuration is that it may detrimentally permit a cover member to contact a moveable flat chain within a trough segment, which may impede movement of the flat chain and/or lead to component damage. To address this concern, in certain embodiments one or more travel stops may be provided (e.g., in or on a trough segment) to limit downward travel of a cover member within a trough. Such an arrangement is shown in FIGS. 7A-7B. FIG. 7A shows a generally cylindrical tubular cover member 26 having a round cross-sectional shape positioned above a trough segment 20 having an internal width W₁ larger than an outer diameter of the cover member 26, with the trough segment 20 having an upper opening 25 and containing a movable flat chain 18 along a bottom wall 21 thereof. Travel stops 82 are provided within an interior of the trough 20 segment at a point between a bottom wall 21 and an upper edge 22 of sidewalls 24 thereof, with the travel 82 stops protruding into the trough interior. The travel stops 82 are positioned above a level of the flat chain 18. FIG. 7B shows the items of FIG. 7A, with the cover member 26 positioned partially within an interior of the trough segment 20, wherein the travel stops 82 prevent further downward travel of the cover member 26 relative to the trough interior and thereby preclude any possibility of the cover member 26 contacting the movable flat chain 18 within the trough segment 20.

Presence of travel stops may be unnecessary if the cover member has a maximum width greater than an internal width of a trough segment, such as shown in FIG. 8. FIG. 8 shows a cover member 26A positioned above a trough segment 20 (having sidewalls 24 extending from a bottom wall 21 to upper edges 22, and bounding a trough opening 25) that contains a movable flat chain 18, with the cover member 26A comprising a cylindrical tube having an outer diameter greater than an internal width of the trough segment 20. Travel stops are not necessary in the embodiment of FIG. 8 to prevent interference between the flat chain 18 and the cover member 26A and are therefore omitted.

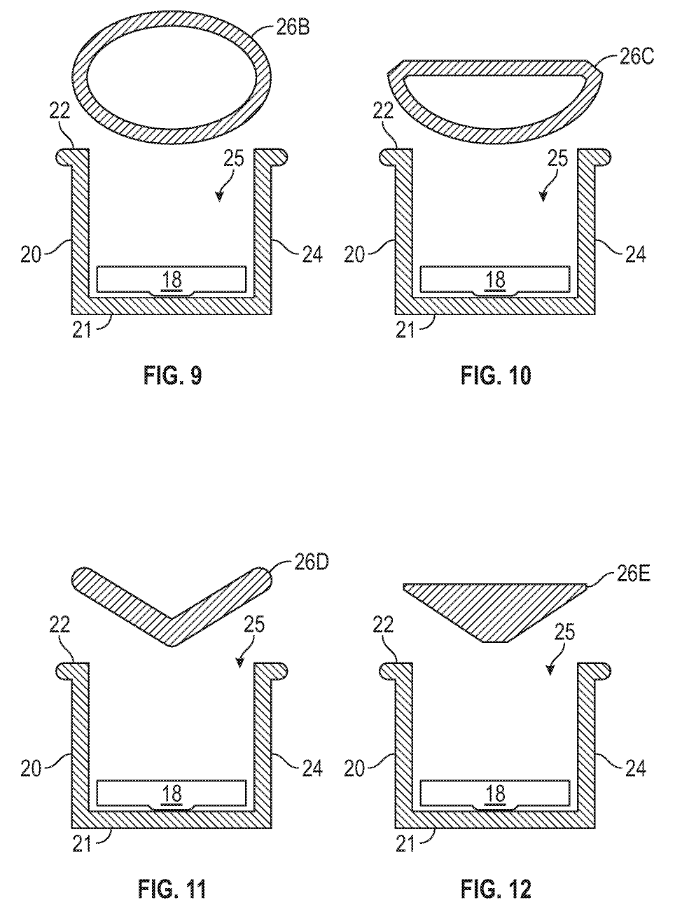

Although various preceding figures have illustrated a cover members (for covering a trough segment) being generally cylindrical with a round cross-sectional shape, the present disclosure is so limited. Cover members useable with animal feed distribution apparatuses disclosed herein may have any suitable cross-sectional shapes. One consideration in selecting an appropriate shape (as well as weight and size) of a cover member is to reduce a likelihood of trapping a body portion (e.g., head) of an animal between a cover member and an upper edge of a trough segment. Providing a tubular cover member with a hollow interior may reduce overall weight of the cover member to reduce a likelihood of animal entrapment. It is anticipated that providing a cover member having a contact angle that is non-parallel to a plane formed by upper edges of the trough segment may also reduce a likelihood of animal entrapment. Examples of various cross-shapes that may be used to form cover members according to certain embodiments include, but are not limited to, elliptical or oval (e.g., FIG. 9), semi-circular, semi-oval (e.g., FIG. 10), chevron-shaped (e.g., FIG. 11), rounded or truncated triangular (e.g., FIG. 12), trapezoidal, rounded trapezoidal and the like.

Each of FIGS. 9-12 includes a trough segment 20 (having sidewalls 24 extending from a bottom wall 21 to upper edges 22, and bounding a trough opening 25) that contains a movable flat chain 18, with a cover member positioned above the respective trough segment 20. FIG. 9 shows a hollow cover member 26B having an oval or elliptical cross-sectional shape. FIG. 10 shows a hollow cover member 26C having a semi-oval cross-sectional shape. FIG. 11 shows a solid cover member 26D having a chevron cross-sectional shape, and FIG. 12 shows a solid cover member 26E having a truncated triangular cross-sectional shape.

In certain embodiments, a cover member may include first and second cover member portions arranged to cover first and second trough segments that are arranged in parallel with one another. In certain embodiments, the first and second trough segments contain a movable flat chain and may include adjacent upper edge portions arranged sufficiently close together (e.g., less than 8 inches, less than 4 inches, less than 2 inches, less than 1 inch, less than .25 inch, or 0 inches; optionally wherein the first and second trough segments may be integrally formed as a single element) to prevent animals such as poultry from feeding from a position between the trough segments. In such an embodiment, the first cover member portion is configured to block animal access to the first trough segment, and the second cover member portion is configured to block animal access to the second trough segment. One or more structural bracing members may be arranged between the first cover member portion and the second cover member portion. In certain embodiments, a movable member is positioned above the cover member (which comprises the first and second cover member portions), at least one tether extends between the movable member and the cover member, and a pivotal link is provided between the movable member and the cover member.

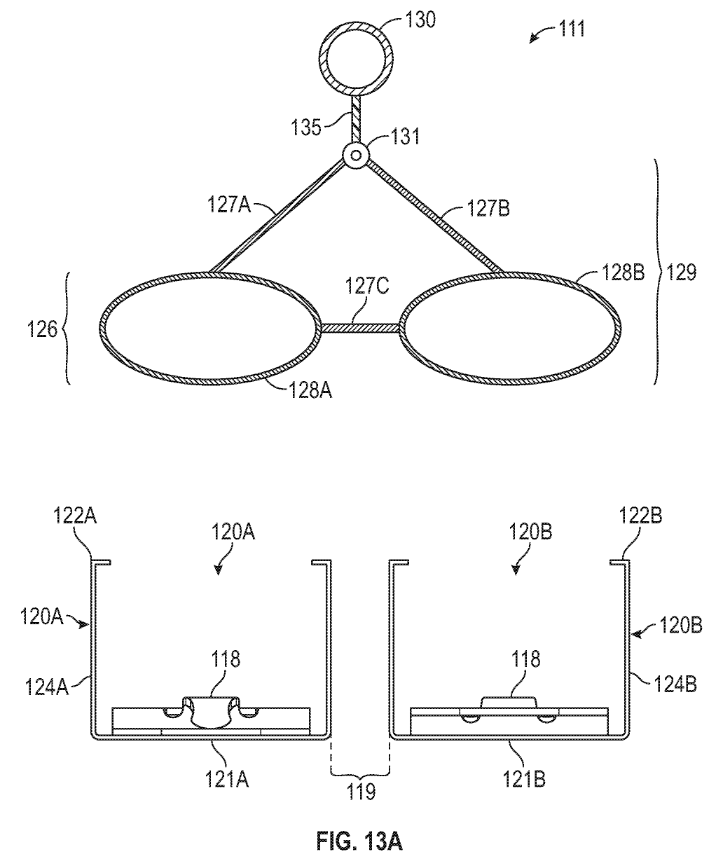

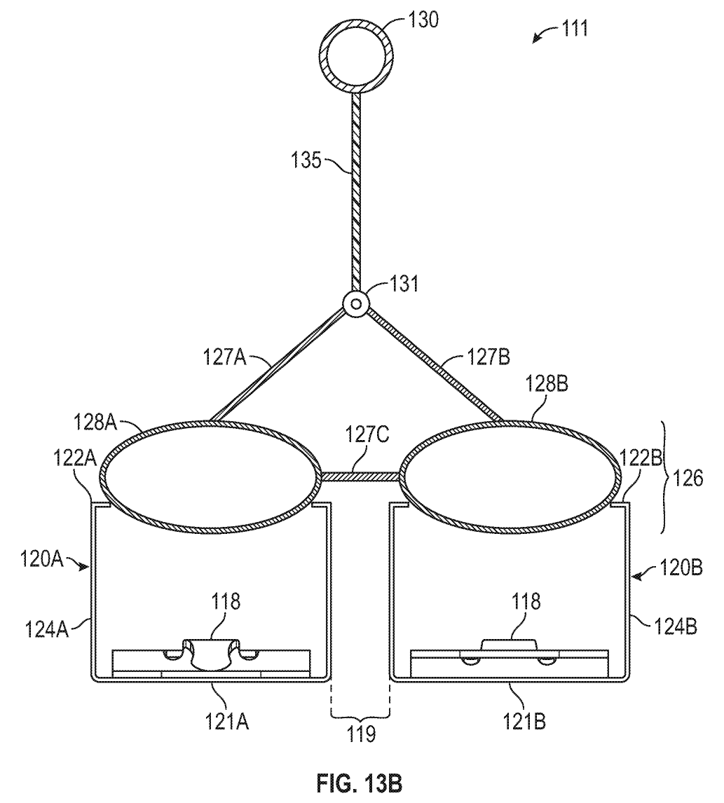

FIG. 13A is a cross-sectional schematic view of a portion of an animal feed distribution system 111 according to one embodiment including a cover member 126 having first and second cover member portions 128A, 128B positioned above corresponding first and second trough segments 120A, 120B containing a movable flat chain 118, with the cover member 126 arranged in an upper, open position. The upper, open position is configured to permit animals (e.g., poultry) to access granular feed material (not shown) distributed within the trough segments 120A, 120B using the movable flat chain 118. FIG. 13B is a cross-sectional schematic view of the animal feed distribution system portion 111 of FIG. 13A, with the cover member 126 arranged in a lower, closed position configured to block animals from accessing feed material in the trough segments 120A, 120B. Each trough segment 120A, 120B includes a bottom wall 121A, 121B and sidewalls 124A, 124B that protrude upward from the corresponding bottom wall 121A, 121B, wherein each sidewall has a corresponding upper edge portion 122A, 122B. The trough segments 120A, 120B are arranged in parallel with one another, and in certain embodiments the upper edge portions 122A, 122B of adjacent sidewalls 124A, 124B may be spaced apart by a distance 119. In certain embodiments, the distance 119 between adjacent upper edge portions is sufficiently small (e.g., less than 8 inches, less than 4 inches, less than 2 inches, less than 1 inch, less than .25 inch, or 0 inches) to prevent animals such as poultry from feeding from a position between the trough segments 120A, 120B, thereby promoting enabling more spacing of animals proximate to the feed distribution system 111 and reducing variability in feed consumption between animals (e.g., poultry). In certain embodiments, the first and second trough segments 121A, 121B may be integrally formed with one another, with a distance 119 between adjacent upper edge portions according to one of the thresholds outlined above (e.g., zero to 8 inches).

With continued reference to FIGS. 13A-13B, the cover member 126 includes first and second cover member portions 128A, 128B that are coupled with structural bracing members 127A-127C (e.g., including a horizontal structural bracing member 127C and inclined structural bracing members 127A, 127B). The structural bracing members 127A-127C may be periodically spaced along a length of the cover member 126. In certain embodiments, a single (e.g., triangular) structural bracing member may substituted for the three structural bracing members 127A-127C depicted in FIGS. 13A-13B. The uppermost structural bracing members 127A, 127B are coupled to a pivotal link 131 that is suspended by tethers 135 from a rotatable shaft 130, wherein directional rotation of the shaft 130 is configured to selectively wrap or unwrap the tethers 135 to adjust height of the cover member 126. A pivotal link 131 is arranged above the structural bracing members 127A-127C to permit pivotal movement of a subassembly 129 (including the cover member portions 128A, 128B and the structural bracing members 127A-127C) relative to a horizontal axis parallel to the bottom walls 121A, 121B of the trough members 120A, 120B. Such pivotal movement may beneficially promote a self-centering function of the cover member 126 relative to openings 125A, 125B of the trough segments 120A, 120B when the cover member portions 128A, 128B are lowered to a position against (or proximate to) upper edge portions of 122A, 122B of the sidewalls 124A, 124B of the trough segments 120A, 120B as shown in FIG. 13B. This pivotal movement may also reduce a likelihood of trapping a body portion (e.g., head) of an animal between a cover member portion 128A, 128B and an upper edge portion 122A, 122B of one of the trough segments 120A, 120B.

Although FIGS. 13A-13B show the cover member portions 128A, 128B as each having an oval cross-sectional shape, it is to be appreciated that in certain embodiments, the cover member portions 128A, 128B may have any suitable shape (including but not limited to the shapes of cover members 26A-26E shown in FIGS. 8-12, respectively).

In certain embodiments, multiple animal feed distribution apparatuses as described herein may be incorporated into an animal feed distribution system, with trough segments of the plurality of animal feed distribution apparatuses arranged as part of a closed circuit containing a continuous flat chain arranged as an endless loop; a plurality of corner sections each coupled to one or more trough segments of the plurality of animal feed distribution apparatuses, with the continuous flat chain extending through the plurality of corner sections; a hopper configured to supply granular feed material into the closed circuit; and a chain drive member configured to move the continuous flat chain to distribute granular feed material through the closed circuit including trough segments of the plurality of animal feed distribution apparatuses. In one embodiment, a feeding circuit may be arranged an elongated rectangular shape with first and second long sides, and two short sides, wherein a first long side includes a first animal feed distribution apparatus as disclosed herein (with a first trough segment, a first movable cover member, and a first actuating mechanism), a second long side includes a second animal feed distribution apparatus as disclosed herein (with a second trough segment, a second movable cover member, and a second actuating mechanism), and the two short sides may include, or may omit, additional animal feed distribution apparatus. In cases where short sides of an animal feeding circuit may be devoid of animal feed distribution apparatuses as disclosed herein, troughs of the short sides may be permanently covered in certain embodiments so as not to interfere with presentation feeding.

In certain embodiments, one or more animal feed distribution apparatuses as disclosed herein (or components thereof) may be retrofitted to existing animal feeding circuits. In certain embodiments, a retrofit kit may include a cover member and some or all components of an actuating mechanism (including but not limited to a shaft, shaft interface members, tethers, etc.) as disclosed herein.

Those skilled in the art will recognize improvements and modifications to the preferred embodiments of the present disclosure. All such improvements and modifications are considered within the scope of the concepts disclosed herein and the claims that follow.

What is claimed is:

1. An animal feed distribution apparatus comprising:
at least one trough segment comprising a trough bottom wall spanning between trough sidewalls, the trough sidewalls comprising upper edges, and the at least one trough segment being configured to receive a movable conveying mechanism for distributing granular animal feed material along a length of the at least one trough segment;
a cover member configured to selectively block animal access to the at least one trough segment, the cover member being movable between (i) a lower, closed position that is proximate to the upper edges of the trough sidewalls and is configured to block animal access to the at least one trough segment and (ii) an upper, open position that is distal from the upper edges of the trough sidewalls and is configured to enable animal access to the at least one trough segment; and
an actuating mechanism configured to move the cover member between the lower, closed position and the upper, open position.

2. The animal feed distribution apparatus of claim 1, wherein the at least one trough segment consists of a single trough segment.

3. The animal feed distribution apparatus of claim 1, wherein:
the actuating mechanism comprises a movable member positioned above the cover member, and at least one tether extending between the movable member and the cover member; and
motion of the movable member is configured to cause the at least one tether to move the cover member between the lower, closed position and the upper, open position.

4. The animal feed distribution apparatus of claim 3, wherein:
the movable member comprises a shaft having a longitudinal axis extending in a longitudinal substantially parallel to the trough bottom wall;
the shaft is configured to rotate around the longitudinal axis;
rotation of the shaft in a first direction is configured to cause a portion of the at least one tether to be wrapped around the shaft to move the cover member from the lower, closed position toward the upper, open position; and
rotation of the shaft in a second direction is configured to cause a portion of the at least one tether to be unwrapped relative to the shaft to move the cover member from the upper open position to toward the lower, closed position.

5. The animal feed distribution apparatus of claim 4, wherein:
the shaft comprises at least one spool region configured to receive a corresponding at least one tether;
rotation of the shaft in the first direction is configured to cause a portion of the at least one tether to be wrapped around the at least one spool region of the shaft; and
rotation of the shaft in the second direction is configured to cause a portion of the at least one tether to be unwrapped relative to the at least one spool region of the shaft.

6. The animal feed distribution apparatus of claim 4, wherein the actuating mechanism further comprises:
a motor or other rotary actuator configured to drive rotation of the shaft; and
a plurality of shaft interface members coupled with the at least one trough segment and configured to support the shaft above the at least one trough segment, with the shaft being permitted to rotate relative to the plurality of shaft interface members.

7. The animal feed distribution apparatus of claim 6, wherein each shaft interface member of the plurality of shaft interface members comprises a bushing or a bearing.

8. The animal feed distribution apparatus of claim 6, wherein each shaft interface member of the plurality of shaft interface members is configured to receive a lifting cable or lifting chain couplable to a winch to permit the entire animal feed distribution apparatus to be raised and lowered.

9. The animal feed distribution apparatus of claim 6, further comprising a roosting prevention member spanning between adjacent shaft interface members of the plurality of shaft interface members.

10. The animal feed distribution apparatus of claim 1, wherein the movable conveying mechanism comprises a movable flat chain.

11. The animal feed distribution apparatus of claim 1, further comprising at least one travel stop positioned within the trough to prevent the cover member from contacting the movable conveying mechanism.

12. The animal feed distribution apparatus of claim 1, wherein the at least one trough segment comprises first and second trough segments arranged in parallel to one another.

13. The animal feed distribution apparatus of claim 12, wherein an upper edge portion of the first trough segment is spaced apart from an adjacent upper edge portion of the second trough segment by a distance of no greater than 8 inches.

14. The animal feed distribution apparatus of claim 12, wherein an upper edge portion of the first trough segment is arranged in contact with an upper edge portion of the second trough segment.

15. The animal feed distribution apparatus of claim 12, wherein the cover member comprises a first cover member portion configured to block animal access to the first trough segment, and comprises a second cover member portion configured to block animal access to the second trough segment.

16. The animal feed distribution apparatus of claim 15, wherein:
the actuating mechanism comprises a movable member positioned above the cover member, and at least one tether extending between the movable member and the cover member;
motion of the movable member is configured to cause the at least one tether to move the cover member between the lower, closed position and the upper, open position; and
the animal feed distribution apparatus further comprises a pivotal link between the movable member and the cover member.

17. The animal feed distribution apparatus of claim 16, further comprising one or more structural bracing members arranged between the first cover member portion and the second cover member portion.

18. An animal feed distribution system comprising:
a plurality of animal feed distribution apparatuses according to claim 1 with trough segments of the plurality of animal feed distribution apparatuses arranged as part of a closed circuit containing a continuous flat chain arranged as an endless loop;
a plurality of corner sections each coupled to one or more trough segments of the plurality of animal feed distribution apparatuses, with the continuous flat chain extending through the plurality of corner sections;
a hopper configured to supply granular feed material into the closed circuit; and
a chain drive member configured to move the continuous flat chain to distribute granular feed material through the closed circuit including trough segments of the plurality of animal feed distribution apparatuses.
